(19) United States
(12) Patent Application Publication
(10) Pub. No.: US 2011/0309774 A1
(43) Pub. Date: Dec. 22, 2011

(54) TEXTILE WITH LIGHTING EFFECT

(76) Inventors: Chi-Tsung Peng, Taipei (TW); Chien-Tang Wang, Taipei (TW)

(21) Appl. No.: 12/821,123

(22) Filed: Jun. 22, 2010

(51) Int. Cl. H05B 39/04; G02B 6/04; F21V 3/04

(52) U.S. Cl. 315/312; 362/311.13; 362/554

(57) ABSTRACT

A textile includes a plurality of opaque filaments, a plurality of transparent and light-guiding filaments, a lighting module and a printed colorful layer. The opaque filaments are spaced from each other in a first direction, and the transparent and light-guiding filaments are spaced from each other in a second direction. The opaque filaments and the transparent and light-guiding filaments are woven as a textile. The printed colorful layer is formed on the surfaces of the opaque filaments and the transparent and light-guiding filaments. When the lighting module provides light in the transparent and light-guiding filaments, the transparent and light-guiding filaments are lighted as a lighting area. Therefore, the printed colorful layer is also lighted, and the colors and patterns thereof are shown.

### BACKGROUND OF THE INVENTION

1. Field of the Invention

The present invention is a textile with lighting effect; especially, the present invention relates to a textile of weaving opaque filaments and transparent and light-guiding filament, a printed colorful layer formed thereon so as to enhance the colorful pattern on the textile.

2. Description of Related Art

Textiles, such as woven band, woven cloth, woven of fibers, and are widely used in life because of its durability and high strength; for example, cervical collars and carrying band for pets, shoelaces, decorating bands on clothes, or painted woven cloth useful as a painting on the wall.

Traditional textile has lighting mechanism thereon. Light source provides light on clothes to show the reflection area or the images. However, the fibers of the textile have pattern(s) thereon which are formed by screen printing. The pattern only has single color. When light projects on the pattern, the pattern or the word is lighted.

In traditional textiles, there are patterns with a single color on the textile. In other words, the method of screen printing cannot meet the requirement of forming colorful patterns on the texture. As a result, the single-color pattern does not improve the lighting variety.

Therefore, the traditional lighting textile has disadvantage in product structure.

Consequently, with regard to the resolution of defects illustrated hereinbefore, the inventors of the present invention propose a reasonably designed solution for effectively eliminating such defects.

### SUMMARY OF THE INVENTION

The objective of the present invention is to provide a textile with lighting effect. The textile can have various colors and patterns. Therefore, the variety of the lighting performance of the textile is improved.

To achieve the objective described as above, the present invention discloses a textile includes a plurality of opaque filaments, a plurality of transparent, light-guiding filaments and a lighting module and a printed colorful layer.

The opaque filaments are spaced apart from each other in a first direction, and the transparent and light-guiding filaments are spaced from each other in a differing second direction. The opaque filaments and the transparent and light-guiding filaments are woven as a textile. On the other hand, the lighting module is disposed on ends of the transparent and light-guiding filaments, and the printed colorful layer is formed on the surfaces of the opaque filaments and the transparent and light-guiding filaments.

Accordingly, when the light generated by the lighting module propagates through the transparent and light-guiding filaments, the transparent and light-guiding filaments provide a lighted or lighting area so as to light and present colors and patterns of the printed colorful layer.

The present invention provides the following beneficial effects: the opaque filaments and the transparent and light-guiding filaments are woven as a textile, and the printed colorful layer is formed on the opaque filaments and the transparent and light-guiding filaments. The lighting module provides light in the transparent and light-guiding filaments, and the transparent and light-guiding filaments are lighted as a lighting area. Therefore, the printed colorful layer is lighted, and the colors and patterns thereof are shown. In other words, the lighting variety of the textile is improved.

In order to further appreciate the characteristics and technical contents of the present invention, references are hereunder made to the detailed descriptions and appended drawings in connection with the present invention. However, the appended drawings are merely shown for exemplary purposes, rather than being used to restrict the scope of the present invention.

### BRIEF DESCRIPTION OF THE DRAWINGS

FIG. 1 is a diagram of the textile without the lighted pattern portion according to the present invention;

FIG. 2 is a diagram of the textile with the lighted pattern portion according to the present invention;

FIG. 3 shows the “Z” portion in FIG. 2.

### DETAILED DESCRIPTION OF THE PREFERRED EMBODIMENTS

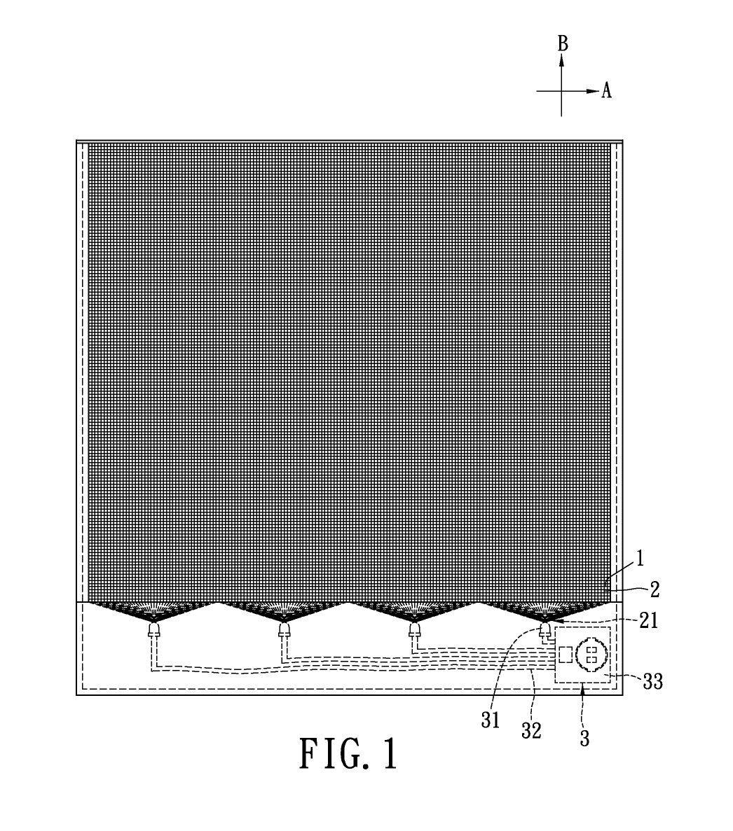

Refer now to FIGS. 1 to 3; the present invention provides a textile with lighting effect. The textile includes a plurality of opaque filaments 1, a plurality of transparent and light-guiding filaments 2, a lighting module 3 and a printed colorful layer 4.

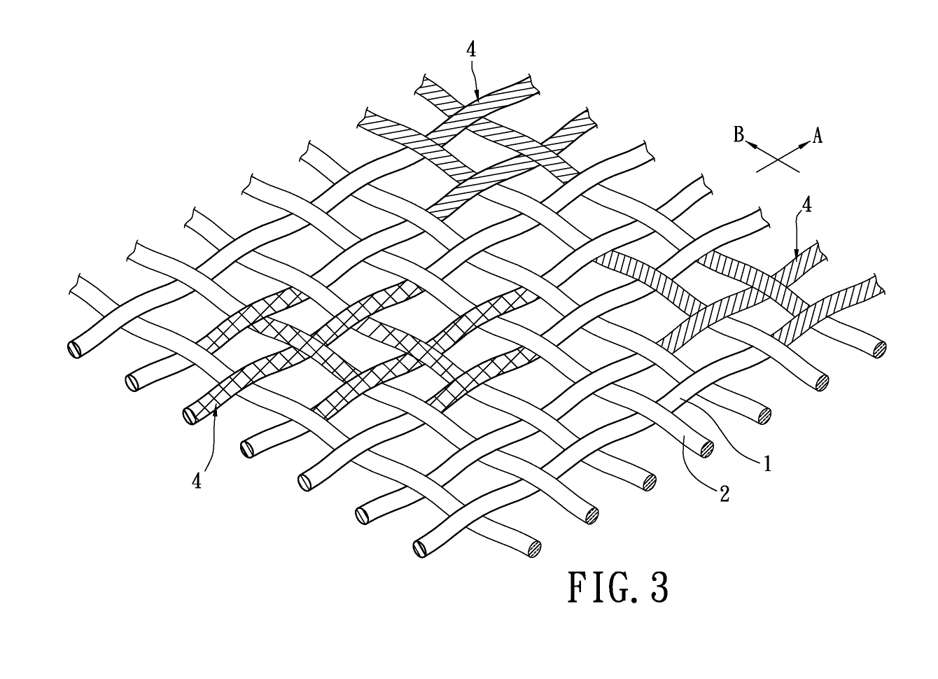

The opaque filaments 1 are spaced from each other in a first warp direction “A” and the transparent/translucent and light-guiding filaments 2 are spaced from each other in another direction, i.e., the second warp direction “B”. Furthermore, the opaque filaments 1 and the transparent and light-guiding filaments 2 are woven as a textile, as shown in FIG. 3. In the embodiment, the first direction “A” represents the longitudinal direction of the textile and the second direction “B” represents the transverse direction of the textile. Alternatively, the first direction “A” can be the transverse direction of the textile and the second direction “B” can be the longitudinal direction of the textile. In other words, the woven directions of the opaque filaments 1 and the transparent and light-guiding filaments 2 can be adjusted depending on the size of the filament. For example, the first direction “A” represents the longitudinal direction of the textile and the second direction “B” represents the transverse direction of the textile when the textile is a woven band, and the first direction “A” represents the transverse direction of the textile and the second direction “B” represents the longitudinal direction of the textile when the textile is a woven cloth.

The opaque fabric 1 can be chemically derived fiber, for example, polyester, wool, other animal hair, cotton, silk, hemp, acrylic, or any non-transparent fiber, and the transparent and light-guiding fabric 2 can be light-guiding fiber or any fiber with flexible, transparent, and light-guiding properties. In the embodiment, the transparent and light-guiding fabric 2 is made of transparent thermoplastic material, for example, Polycarbonate, Polystyrene, Polymethyl Methacrylate, MMA Styrene Copolymer, Thermoplastic Polyurethane, and Ethylene Vinyl Acetate, but not limited thereby.

The lighting module 3 is disposed on ends of the transparent and light-guiding filaments 2. The lighting module 3 includes at least one lighting unit 31 for generating the light, at least one light-conductive fiber 32 and a controlling unit 33. The light-conductive fiber 32 is connected between the lighting unit 31 and the controlling unit 33 so that the controlling unit 33 can be used to control the lighting unit 31. Furthermore, the ends of the transparent and light-guiding filaments 2 are collected to form at least one light inlet 21. The lighting unit 31 aligns to the light inlet 21 so as to project light to the light inlet 21. In the embodiment, the lighting unit 31 is LED(s).

Accordingly, light of the lighting unit 31 is guided inside the transparent and light-guiding filaments 2 through the light inlet 21. When light propagates in the transparent and light-guiding filaments 2, the transparent and light-guiding filaments 2 perform as a lighting area of the textile. On the other hand, the controlling unit 33 is used to control the lighting mode of the lighting unit 31, for example, continuous lighting, flicker lighting, or to control the colors of light in order to switch the colors.

The printed colorful layer 4 has at least two colors and may be formed on the opaque filaments 1 and the transparent and light-guiding filaments 2. Further, the printed colorful layer 4 can be scenery pattern, personage pattern, word(s) or the combination thereof.

As above-mentioned, when the transparent and light-guiding filaments 2 perform as a lighting area of the textile, the light of the lighting area can used to light the printed colorful layer 4 and simultaneously present colors of the printed colorful layer 4.

In detail, the printed colorful layer 4 is a layer which is formed by ink-jet printing colors on the surfaces of the opaque filaments 1 and the transparent and light-guiding filaments 2. In other words, the layer 4 has colorful patterns thereon which are formed by ink jet printing methods. Therefore, the product of the textile has variety.

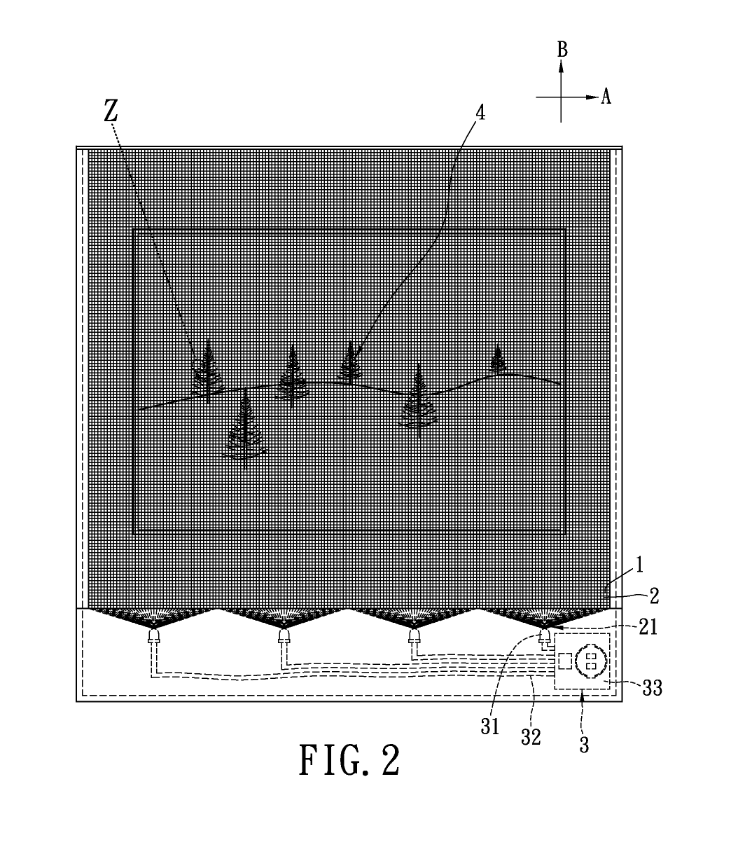

Please refer to FIG. 2 again; the textile of the present invention can be a cloth having the scenery patterns thereon. In other words, the textile of the present invention can be used in various applications.

Certainly, the opaque filaments 1 and the transparent and light-guiding filaments 2 are woven together, and the printed colorful layer 4 is formed on the transparent and the transparent and light-guiding filaments 2. Therefore, when light transmits through the transparent and light-guiding filaments 2 to be a lighting area, the printed colorful layer 4 is lighted by lights of the lighting area. By the combination of the printed colorful layer 4 and the textile, the variety of the lighted pattern of the textile is improved.

The text set forth hereinbefore illustrate simply the preferred embodiments of the present invention, rather than intending to restrict the scope of the present invention claimed to be legally protected thereto. All effectively equivalent changes made by using the contents of the present disclosure and appended drawings thereof are included within the scope of the present invention delineated by the following claims.

What is claimed is:

1. A textile with lighting effect, comprising:
a plurality of opaque filaments spaced from each other in a first direction;
a plurality of transparent and light-guiding filaments spaced from each other in a second direction, the opaque filaments and the transparent and light-guiding filaments being woven as a textile;
a lighting module, disposed on ends of the transparent and light-guiding filaments; and
a printed colorful layer, formed on the opaque filaments and the transparent and light-guiding filaments;
wherein the lighting module provides light along the transparent and light-guiding filaments to form a lighting area, and the lighting area is used to light the printed colorful layer and to present colors of the printed colorful layer.

2. The textile with lighting effect according to claim 1, wherein the transparent and light-guiding filaments are light-guiding fibers.

3. The textile with lighting effect according to claim 1, wherein the first direction is a longitudinal direction of the textile and the second direction is a transverse warp direction of the textile, or the first direction is a transverse direction of the textile and the second direction is a longitudinal direction of the textile.

4. The textile with lighting effect according to claim 1, wherein the lighting module includes a lighting unit generating the light, a light-conductive fiber and a controlling unit, the light-conductive fiber is connected between the lighting unit and the controlling unit, and the controlling unit controls the lighting unit.

5. The textile with lighting effect according to claim 4, wherein the ends of the transparent and light-guiding filaments are collected to form at least one light inlet, and light of the lighting unit is projected to the light inlet.
